(19) United States
(12) Patent Application Publication
(10) Pub. No.: US 2010/0026518 A1
(43) Pub. Date: Feb. 4, 2010

(54) Measuring system having a sensor module and a transmitter module

(75) Inventors: Michael Kirst, Lorrach (DE); Peter Lindmuller, Essingen (DE); Martin Hertel, Steinen (DE); Paul Ceglia, Basel (CH)

Correspondence Address: BACON & THOMAS, PLLC, 625 SLATERS LANE, FOURTH FLOOR, ALEXANDRIA, VA, 22314-1176, US

(73) Assignee: Endres + Hauser Flowtec AG, Reinach (CH)

(21) Appl. No.: 12/457,663

(22) Filed: Jun. 18, 2009

Related U.S. Application Data
(60) Provisional application No. 61/129,440, filed on Jun. 26, 2008.

(30) Foreign Application Priority Data
Jun. 26, 2008 (DE) 10 2008 029 956.1

(51) Int. Cl. G08C 19/06

(52) U.S. Cl. 340/870.05

(57) ABSTRACT

The sensor module includes: a sensor housing; at least one measuring transducer arranged at least partially in the sensor housing for registering at least one measured variable and for producing at least one primary signal influenced by the measured variable; as well as sensor electronics arranged within the sensor housing and connected with the measuring transducer for converting the primary signal delivered from the measuring transducer into a sensor signal. Further provided in the sensor electronics is an energy supply unit, which includes at least one energy storer arranged within the sensor housing for storing energy to be converted in the measuring system. The transmitter module is coupled to the sensor module and includes a transmitter housing and a transmitter electronics accommodated in the transducer housing and electrically coupled with the sensor electronics for converting the sensor signal delivered from the sensor module into measured values representing the at least one measured variable.

### CROSS-REFERENCE TO RELATED APPLICATION

This application is a Nonprovisional Application which claims the benefit of U.S. Provisional Application No. 61/129,440 filed on Jun. 26, 2008.

### TECHNICAL FIELD

The invention relates to a measuring system formed by means of a sensor module and by means of a transmitter module for measuring at least one physical and/or at least one chemical, measured variable, for instance a pH-value, temperature, pressure, fill level, flow, etc. of an, at least partially, fluid medium, such as, for instance, a liquid, held in a container and/or conveyed in a pipeline.

### BACKGROUND DISCUSSION

Such modularly constructed measuring systems used in industrial measurements technology, or individual components thereof, are described, for example, in U.S. Pat. No. 6,145,392, U.S. Pat. No. 6,366,346, U.S. Pat. No. 6,476,520, U.S. Pat. No. 6,705,898, U.S. Pat. No. 6,822,431, U.S. Pat. No. 6,898,980, U.S. Pat. No. 5,764,928, U.S. Pat. No. 5,253,537, US-1 2007/0090963, EP-A 1 403 832 EP-A 1 108 992, EP-A 12 21 023, EP-A 062 531, WO-A 08058991, WO-A 08/059019, WO-A 07/124834, WO-A 05/015130, WO-A 97/35190, DE-A 10 2006 0621184, DE-A 102 18 606 A1, PCT/EP2008/051723 or PCT/EP/2007/063462 and include, usually: a sensor module having, usually held on the container, or the pipeline system and/or contacting or protruding at least partially into the medium, a measuring transducer for registering the at least one measured variable and for producing at least one, primary signal influenced by the measured variable, and, connected with the measuring transducer; sensor electronics, on occasion one formed also by means of a microprocessor, for converting the primary signal delivered by the measuring transducer into a sensor signal—on occasion, a sensor signal which is also digital. Moreover, such measuring systems include also a transmitter module mechanically connected, especially rigidly, with the sensor module and having transmitter electronics electrically coupled with the sensor electronics and, on occasion, formed by means of a microprocessor, for converting the sensor signal delivered by the sensor module, on occasion transmitted from the sensor electronics to the transmitter electronics through a galvanic isolation point, into measured values representing the at least one measured variable. The aforementioned, galvanically isolated point can be, for example, an inductive interface formed by means of a transformer for feeding the sensor with electrical power, especially on the basis of an impressed current and/or an impressed voltage. The transmission of data, such as, perhaps, measurement data generated by the sensor module, or configuration data or parametering data provided by the transmitter module for the sensor module, can occur, for example, via the same inductive interface by corresponding modulation of the current and/or the voltage by the module sending the particular data.

Industrial grade measuring systems, which are to be operated also in explosion endangered regions, must also satisfy very high safety requirements as regards explosion protection. In such case, of special concern is the certain prevention of the formation of sparks or at least the assuring that a spark possibly arising in the interior of a closed space does not have any effects on the environment, in order thus to prevent, with certainty, a potentially possible triggering of an explosion. Such as, for example, also explained in this regard in the above cited EP-A 1 669 726, U.S. Pat. No. 6,366,436, U.S. Pat. No. 6,556,447 or US-A 2007/0217091, there are distinguished, in connection with explosion protection, different ignition protection types. Each type is correspondingly manifested in one or more pertinent standards and norms concerning electrical operating means for explosion endangered regions. Examples of such standards include US-American standard FM3600, the international standard IEC 60079-18 or the norms DIN EN 50014 ff. Thus, for example, according to European norm EN 50 020:1994, explosion protection is present, when devices are constructed according to the ignition protection type, or also protection class, defined therein and bearing the name “Intrinsic Safety” (Ex-i). According to this protection class, the values for the electrical quantities, current, voltage and power, in a device, must, at all times, lie, in each case, below a predetermined limit value. The three limit values are so selected, that, in the case of a malfunction or defect, e.g. because of a short circuit, the maximum arising heat is not sufficient to produce an ignition spark. The electrical current is kept, e.g. by resistors, the voltage, e.g. by Zener diodes, and the power by corresponding combinations of current and voltage limiting components, below the specified limit values.

In European norm EN 50 019:1994, another protection class with the name “Increased Safety” (Ex-e) is given. In devices, which are constructed according to this protection class, the ignition, or explosion, protection is achieved by making the spatial separations between two different electrical potentials sufficiently large, that a spark formation cannot arise, even in the case of a defect, because of the distance. This can, however, in given circumstances, lead to the fact that circuit arrangements must have very large dimensions, in order to satisfy these requirements. Another protection class, provided in the European norm EN 50 018:1994, is, furthermore, the ignition protection type “Pressure Resistant Encapsulation” (Ex-d). Measuring systems or system modules constructed according to this protection class must have a pressure resistant housing, by which it is assured, that an explosion occurring in the interior of the housing cannot be transmitted into the external space. Pressure resistant housings are, in order that they have a sufficient mechanical strength, constructed with comparatively thick walls. In the USA, in Canada, in Japan, and other countries, there are standards comparable with the above-cited European norms. Therefore, the transmitter electronics is usually accommodated in a hermetically sealed, most often also pressure, or explosion, resistant, transmitter housing, which is, on occasion, correspondingly filled with a potting compound for the transmitter electronics, while the sensor electronics is arranged in a corresponding, separate, sensor housing, which accommodates, at least partially, also the measuring transducer.

Measuring systems of the type discussed are, additionally, most often, integrated into a superordinated, electronic, data processing system, especially a topologically very widely extended, data processing system, serving, for example, for the automatic control of a processing plant including the measuring system. An example of such a data processing system is a process control system (PCS) and/or a measuring and control circuit formed by means of a programmable logic controller (PLC), for example using a 4-20 mA current loop or a digital field bus, such as, for example, PROFIBUS, FOUNDATION FIELDBUS, MODBUS, etc., and/or radio connection, to which data processing system measured values produced by the pertinent measuring system are forwarded, near in time, on occasion encapsulated into a corresponding telegram. By means of such data processing systems, the transmitted, measured values can be processed further, and visualized, as corresponding measurement results, e.g. on monitors, and/or converted into control signals for field devices, such as e.g. magnetically operated valves, etc., embodied as actuators. Since modern industrial measurement systems, most often, can also be monitored directly from such control computers and, on occasion, controlled and/or configured therefrom, in corresponding manner, operating data intended for the electronic device are likewise transmitted over the data transmission networks, which are most often hybrid as regards the transmission physics and/or the transmission logic. In the data processing system, based on a plurality of measured values produced by means of a plurality of such measurement systems and based on complex parameters correspondingly derived therefrom, thus, a comprehensive control and monitoring of the processing plant can occur.

For connecting a data processing system and a measuring system, such further includes, most often, a corresponding receiver module with receiver electronics, most often relatively widely removed from the transmitter module, for example connected to the possibly present field bus. The transmitter electronics, especially as electrically connected to the receiver module by means of a 2, or 4, wire, connecting line, such as, for instance, a 4-20 ma current loop, or RS485, sends to the receiver module, especially at times, a measured value, especially an analog measured value and/or a measured value encapsulated in a telegram transmitted via connection line and/or wirelessly per radio, and/or a current operating state of the transmitter module and/or a parameter value signaling current operating state of the transmitter module and/or the sensor module. The receiver module serves, especially, also for conditioning measured values delivered by the measuring system such that the measured values are in form corresponding to the requirements of downstream data transmission networks, for example suitably to digitize them or, on occasion, convert them into a corresponding telegram, and/or to evaluate them on site. For this purpose, there are provided in the electronics of such receiver modules corresponding converter circuits, which preprocess and/or further process, measured values received from pertinent measuring systems, as well as, in case required, suitably convert them.

Besides the evaluating circuits required for the processing and converting of the measured values delivered from the pertinent, connected field devices, such receiver modules include, most often, also electrical power supply circuits serving for the supply of the connected transmitter module with electrical energy. These power supply circuits provide a corresponding, internal, supply voltage, on occasion directly fed from the connected field bus, for the entire measuring system. A supply circuit can, in such case, be associated with exactly one measuring system and accommodated in a receiver module housing, for example a receiver module housing in the form of a top hat, rail module, shared, for example, with the evaluating circuit associated with the particular field device, for example united as one receiver module serving as fieldbus adapter. It is, however, also quite usual to accommodate supply circuits and evaluating circuits each in separate electronics housings, on occasion situated spatially removed from one another, and to wire them appropriately with one another via external lines.

In the case of modularly constructed measuring systems, it is, as shown for example in U.S. Pat. No. 6,705,898 or EP-A 1 108 992, additionally quite usual, following startup of the measuring system, from time to time, to replace one of the two modules, on site, with a new one of equal construction or at least of equal type. As shown, for example, in the initially mentioned U.S. Pat. No. 6,705,898, the sensor housing and the transmitter housing can, for such purposes, be constructed, in each case, as mutually complementary, especially hermetically tight, pluggable elements, which can be connected releasably with one another by plugging them together.

As already mentioned, conventional, modular, measuring systems of the type being discussed, especially in the case of a field bus connected thereto, draw the electrical power, or energy, required for operation usually directly from the data processing system by means of a supply circuit placed in the receiver module. Thus, the data processing system forms, also, the supply network feeding the measuring system. For the infeeding of electrical power into the transmitter module, the receiver module includes a corresponding energy supply unit, for instance an energy supply unit in the form of a switching power supply, or in the form of a voltage regulator. However, in the case of such measuring systems, in which the transmitter electronics draws, in operation, the needed electrical power from the energy supply unit of the receiver module, a, when only temporary, breakdown of the, from the point of view of energy supply, primary-side, transmitter module and/or the receiver module can lead to an interruption of the energy supply of the sensor module. This can cause, on the one hand, loss of measured values of the measuring point formed by means of the measuring system for the time of the supply interruption, while, on the other hand, a restart of the measuring system would be required, when the power, or energy, supply to the same is again resumed following the interruption. Additionally, in the case of possible interruption of the energy supply implemented via transmitter module, perhaps because of a defect, or in the course of a checking of the transmitter module, at times, sensor functions, which require a lasting energy supply, such a perhaps the permanently to be maintained polarization voltage in the case of amperometric sensors, can be lastingly disturbed and even damaged.

There are, additionally, also industrial measurement systems known, on occasion even modularly constructed, industrial measurement systems, for example from U.S. Pat. No. 7,293,470, U.S. Pat. No. 6,237,424, U.S. Pat. No. 6,952,970 or the above mentioned US-A 2007/0090963, which at least partially cover their need for electrical power, alternatively or supplementally to the external energy supply, by means of internal, especially electrochemical, energy storers, such as, perhaps, primary batteries and/or rechargeable, secondary batteries, in the case of which, thus, the energy supply unit delivers at least partially feeding, electrical power, at least at times, to a component of the measuring system, for example, thus the sensor electronics and/or the transmitter electronics, by exploiting energy stored in the energy storer. These energy storers are usually placed within the housing part of the measuring system accommodating the transmitter electronics—thus, in the case of modularly constructed measuring system, in the corresponding transmitter housing, or, as shown in US-A 2007/0090963, in a separate, battery housing connected releasably with the transmitter housing. For the mentioned case, in which the transmitter module draws electrical power during operation fed externally of the transmitter module from the energy supply unit of the receiver module, the electrical power, drawn on occasion by the transmitter module from the energy supply unit of the receiver module, can, as shown, for example, in EP-A 082 531, also serve for recharging the energy storer of the energy supply unit of the measuring system. For the purpose of replacing used energy storers, be it, now, a discharged primary battery or a no longer sufficiently rechargeable, secondary battery, either the transmitter housing or the, on occasion, present battery housing, must be opened and, with that, the total measuring system must be turned off.

Especially in the case of application of such a measuring system (on occasion even an energetically autarkic, measuring system, thus a measuring system electrically fed solely by means of onboard energy storers) in an explosion endangered environment, the energy supply unit is, for reasons of safety, additionally at least partially embedded in a potting compound and/or the energy supply unit includes components limiting the maximally releasable, electrical power.

A special problem of such measuring systems operated by means of internal energy storers is, however, presented by the finite storer capacity of the energy storer and by the limited, nominal, operating time. Associated with this, also the nominally maintenance free, service life of measuring systems of the type being discussed is very limited. This can, especially in the case of energetically autarkic measuring systems, lead to the fact that, in relatively short time intervals, appropriately schooled, service personnel have to check the measuring system on site and/or, on schedule, replace the batteries, with these activities being coupled, if required, with a temporary shutdown of the entire measuring system. In the case of measuring systems having a sensor equally in need of regular checking or regular replacement within specified time intervals, such as is the case, for instance, in the case of potentiometric sensors, turbidity sensors, biosensors, optical sensors, conductivity sensors, etc, the corresponding service dates can, it is true, be directly so set with respect to one another, that the checking and possible replacement of the pertinent sensors and of the pertinent batteries can occur on the same schedule. However, at least in the case of conventional, energetically autarkic measuring systems of the type being discussed, it is still necessary that the transmitter electronics, which is still there, must be turned off, and thus the measuring system, as a whole, has to be deactivated.

### SUMMARY OF THE INVENTION

Proceeding from the state of the art, an object of the invention is to improve measuring systems with their internal energy storers serving for their power supply, such that the energy storers are easy to replace by service personnel on site, especially also in the course of a possibly required replacement of the sensor module.

For achieving the object, the invention resides in a measuring system for measuring at least one physical and/or at least one chemical, measured variable, wherein the measuring system includes:
a sensor module, especially an energetically autarkic, sensor module, wherein the sensor module includes
a sensor housing, especially a sensor housing embodied as a pluggable element and/or explosion resistant and/or pressure resistant sensor housing,
at least one measuring transducer arranged at least partially in the sensor housing for registering at least one measured variable and for producing at least one primary signal influenced by the measured variable,
a sensor electronics arranged within the sensor housing and connected with the measuring transducer, especially a sensor electronics formed by means of a microprocessor, for converting the primary signal delivered by the measuring transducer into a sensor signal, especially a digital sensor signal and/or a sensor signal transmittable via a galvanic isolation point, and
an energy supply unit, especially an energy supply unit embedded at least partially into a potting compound and/or having a component limiting a maximally releasable electrical power, wherein the energy supply unit includes at least one energy storer arranged within the sensor housing, especially an electrochemical and/or a rechargeable, energy storer, for storing energy to be converted in the measuring system; as well as
a transmitter module coupled to the sensor module, especially a transmitter module forming a pluggable connection, especially a transmitter module releasably connected to the sensor module and/or a transmitter module connected to the sensor module via a connection cable, wherein the transmitter module includes
a transmitter housing, especially a transmitter housing formed as a pluggable element, and
transmitter electronics accommodated in the transmitter housing and electrically coupled, especially electrically coupled with galvanic isolation, with the sensor electronics, especially a transmitter electronics formed by means of a microprocessor, for converting the sensor signal delivered from the sensor module, especially a sensor signal transmitted from the sensor electronics to the transmitter electronics via galvanic isolation point, into measured values representing at least one measured variable, especially analog measured values and/or measured values encapsulated in a telegram transmittable via fieldbus and/or wirelessly per radio and/or digital measured values.

In a first embodiment of the invention, it is provided that the energy supply unit delivers, at least at times, utilizing energy stored in the energy storer, electrical power feeding, at least partially, the sensor electronics and/or the transmitter electronics.

In a second embodiment of the invention, it is provided that the transmitter module draws, during operation, at least at times and/or at least in part, electrical power from the energy supply unit of the sensor module.

In a third embodiment of the invention, it is provided that the transmitter module draws, during operation, electrical power fed from externally of the transmitter module, especially predominantly or exclusively, from the energy supply unit of the sensor module.

In a fourth embodiment of the invention, it is provided that the transmitter module is supplied with electrical energy, at least partially, especially predominantly or exclusively, by means of the energy supply unit of the sensor module from externally of the transmitter module.

In a fifth embodiment of the invention, it is provided that electrical power required for operating the transmitter electronics is provided, at least partially, especially predominantly or exclusively, utilizing energy stored in the energy storer of the energy supply unit of the sensor module.

In a sixth embodiment of the invention, it is provided that the transmitter electronics draws electrical power during operation, at least at times and/or at least in part, from the energy supply unit of the sensor module.

In a seventh embodiment of the invention, it is provided that electrical power required for operating the sensor electronics is provided, at least in part, especially predominantly or exclusively, utilizing energy stored in the energy storer of the energy supply unit of the sensor module.

In an eighth embodiment of the invention, it is provided that the sensor electronics draws electrical power, during operation, at least at times and/or at least in part, especially predominantly, from the energy supply unit of the sensor module.

In a ninth embodiment of the invention, it is provided that the energy storer of the energy supply unit of the sensor module is so sized, that the energy storer, when fully charged, maintains operation at least of the sensor module, especially, however, also the operation of both the sensor module and the transmitter module, for at least 10 days, especially more than a month, and/or that the energy storer has a storage capacity of at least 3000 mWh, especially more than 5000 mWh, and/or that the energy storer, at a nominal voltage of at least 1 volt, especially more than 3 volt, has a nominal capacity of at least 1000 mAh, especially more than 1500 mAh.

In a tenth embodiment of the invention, it is provided that the energy storer of the energy supply unit of the sensor module is formed by means of a primary battery, especially a primary battery which cannot be recharged and/or a thin-film battery, and/or by means of a secondary battery (accumulator), especially a secondary battery which can be recharged during operation and/or a secondary battery embodied as a thin-film battery, and/or by means of a capacitor, especially an electrolytic capacitor, especially an electrochemical, double-layer capacitor.

In an eleventh embodiment of the invention, it is provided that the energy storer of the energy supply unit of the sensor module is formed by means of a lithium battery, especially a lithium, manganese dioxide battery (Li—MnO₂), lithium, thionyl chloride battery (Li—SOCl₂), lithium, carbon monofluoride battery (Li—{CFₙ}), lithium, iodine battery (Li—I₂) and/or by means of a lithium ion accumulator (Li-ion).

In a twelfth embodiment of the invention, it is provided that the energy storer of the energy supply unit of the sensor module is formed by means of a lithium, iron, phosphate accumulator (LiFe—PO₄), by means of a lithium titanate accumulator, by means of a lithium, cobalt, nickel oxide accumulator, by means of a lithium, manganese oxide accumulator, by means of a lithium, polymer accumulator (LiPoly), by means of a sodium, sulfur accumulator and/or by means of a nickel, metal hydride accumulator.

In a thirteenth embodiment of the invention, it is provided that the energy storer of the energy supply unit of the senor module is formed by means of a double-layer capacitor (EDLC), especially a Goldcap, Supercap, Boostcap or Ultracap, double-layer capacitor.

In a fourteenth embodiment of the invention, it is provided that the energy supply unit of the sensor module includes electrical current limiters and/or voltage limiters for limiting electrical power maximally releasable from its energy storer.

In a fifteenth embodiment of the invention, it is provided that the energy supply unit of the sensor module includes a charge measuring circuit monitoring a charge state of the at least one energy storer and/or ascertaining a remaining charge of the energy storer, especially a still usable, remaining charge, wherein the charge measuring circuit delivers, during operation, at least at times, a charge measurement signal representing an instantaneous charge state of the at least one energy storer.

In a sixteenth embodiment of the invention, it is provided that the measuring system, especially the transmitter electronics, ascertains, during operation, based on the charge measurement signal generated by the charge measuring circuit, a diagnostic value, which represents an estimated remaining charge of the energy storer and/or a remaining operating time predicted for the sensor module. Developing this embodiment of the invention further, it is provided that the measuring system, especially the transmitter electronics, compares the ascertained, diagnostic value with a predetermined reference value, which serves as an alarm threshold for a remaining charge classified as a critical operating state of the measuring system and/or for impending discharge of the energy storer, and wherein the measuring system, especially the transmitter electronics, based on the comparison of diagnostic values and reference value at detected critical operating state, generates an alarm signaling such, especially an alarm signaling visually on site and/or remotely from the measuring system. Alternatively or in supplementation, for the case, in which a digital signal serves as sensor signal, the measuring system, especially the sensor electronics, can, based on the ascertained diagnostic value, control a clocking rate, with which the sensor electronics generates the sensor signal.

In a seventeenth embodiment of the invention, it is provided that the transmitter module transmits to the sensor module during operation at least one time value, which represents a current system time of the measuring system, especially a current date.

In an eighteenth embodiment of the invention, it is provided that the transmitter module further includes an energy supply unit, especially an energy supply unit at least partially embedded in a potting compound and/or having a component limiting maximally releasable, electrical power, having at least one energy storer, especially a rechargeable electrical storer, feeding the electrical supply unit with electrical energy and placed within the transmitter housing, wherein the energy supply unit delivers, utilizing energy stored in the energy storer, at least at times, electrical power feeding, at least partially, the transmitter electronics and/or the sensor electronics. Developing this embodiment of the invention further, in a first further development of the eighteenth embodiment, it is further provided that the sensor module draws, during operation, at least at times, electrical power from the energy supply unit of the transmitter module. In a second further development of the eighteenth embodiment, it is further provided, that
the energy storer of the energy supply unit of the transmitter module is so sized that the energy storer, when fully charged, maintains operation, at least of the transmitter module, at least for 10 minutes, especially more than 1 hour, and/or the energy storer has a storage capacity of more than 10 mWh and/or it has, at a nominal voltage of at least 1 volt, especially more than 3 volt, a nominal capacity of at least 1 mAh, especially more than 5 mAh; and/or
the energy storer of the energy supply unit of the transmitter module is formed by means of a capacitor, especially an electrolytic capacitor, especially a double-layer capacitor (EDLC), and/or by means of a secondary battery, especially a lithium, iron, phosphate accumulator (LiFe—PO₄), a lithium titanate accumulator, a lithium, cobalt, nickel oxide accumulator, a lithium, manganese oxide accumulator, a lithium, polymer accumulator (LiPoly), a sodium, sulfur accumulator and/or by means of a nickel, metal hydride accumulator.

In a third further development of the eighteenth embodiment, it is further provided that the energy supply unit of the transmitter module includes electrical current limiters and/or voltage limiters for limiting electrical power maximally releasable from its energy storer.

In a fourth further development of the eighteenth embodiment, it is further provided that the energy storer of the energy supply unit of the transmitter module is rechargeable, especially during operation of the transmitter module.

In a nineteenth embodiment of the invention, it is provided that the sensor electronics includes at least one non-volatile, especially persistent, data memory for
storing at least one section of a data signal generated by means of the sensor module, especially a section marked by means of a time stamp representing a point in time of the generation, especially a data signal based on its at least one primary signal and/or
storing measured values generated by means of the transmitter module, especially measured values, marked, in each case, by means of a time stamp representing an associated storage time and/or an associated storage date and/or
storing transmitter data identifying the transmitter module for the sensor module, especially transmitter data specifying the transmitter module and/or authenticating the transmitter module relative to the sensor module, especially transmitter data in the form of transmitter type identifiers and/or certificates issued for the transmitter module and/or operating approvals granted for the transmitter module.

In a twentieth embodiment of the invention, it is provided that the sensor electronics includes at least one non-volatile, especially permanent, data storer for storing sensor data identifying the sensor module for the transmitter module, especially sensor data specifying the sensor module and/or authenticating the sensor module relative to the transmitter module, especially sensor data in the form of sensor type identifiers, calibration data specifying the sensor module and/or operating parameters serving for a parametering of the transmitter module and/or certificates issued for the sensor module and/or operating approvals granted for the sensor module and/or enabling codes serving for activating the transmitter module.

In a twenty-first embodiment of the invention, it is provided that the transmitter electronics includes at least one non-permanent, especially persistent, data memory for
storing measured values generated by means of the transmitter module, especially measured values marked by means of a time stamp representing a point in time of the pertinent generating, and/or
storing sensor data identifying the sensor module for the transmitter module, especially sensor data specifying the sensor module, and/or
storing sensor data authenticating the sensor module relative to the transmitter module, especially sensor data in the form of sensor type identifiers and/or calibration data specifying the sensor module and/or certificates issued for the sensor module and/or operating approvals granted for the sensor module and/or enabling codes serving for activating the sensor module.

In a twenty-second embodiment of the invention, it is provided that the transmitter electronics includes at least one non-volatile, especially permanent, data memory for storing transmitter data identifying the transmitter module for the sensor module, especially transmitter data specifying the transmitter module and/or authenticating the transmitter module relative to the sensor module, especially transmitter data in the form of transmitter type identifiers and/or operating parameters serving for a parametering of the sensor module and/or certificates issued for the transmitter module and/or operating approvals granted for the transmitter module and/or enabling codes serving for activating the sensor module.

In a twenty-third embodiment of the invention, it is provided that the measuring system further includes a receiver module remote from the transmitter module, especially a receiver module connected to a fieldbus and/or to a superordinated, electronic, data processing system, wherein the receiver module includes a receiver electronics, wherein the transmitter electronics, especially the transmitter electronics electrically connected to the receiver electronics by means of connecting line, transmits to the receiver electronics, at least at times, a measured value, especially an analog measured value and/or a measured value encapsulated in a telegram transmittable via a connecting line and/or wirelessly per radio, and/or a parameter value signaling a current operating state of the transmitter module and/or of the sensor module.

In a first further development of the twenty-third embodiment, it is further provided that the transmitter module transmits to the receiver module, especially automatically, at the latest at interrupted communication between sensor module and transmitter module, especially as a result of turn off or removal of the sensor module, at least one parameter value, which signals, that the sensor module is momentarily out of operation.

In a second further development of the twenty-third embodiment, it is additionally provided that the receiver module includes an energy supply unit for feeding electrical power into the transmitter module. In this way, the transmitter module, especially the transmitter electronics, can draw, during operation, at times and/or in part, electrical power from the energy supply unit of the receiver module, or, as the case may be, electrical power drawn by the transmitter module from the energy supply unit of the receiver module can serve, at least partially, for the recharging of the energy storer, should such be present in the energy supply unit of the transmitter module.

In a third further development of the twenty-third embodiment, it is additionally provided, that the transmitter module draws electrical power fed during operation externally of the transmitter module partly from the energy supply unit of the receiver module.

In a fourth further development of the twenty-third embodiment, it is further provided that the transmitter module is supplied with electrical energy externally of the transmitter module partly by means of the energy supply unit of the receiver module.

In a fifth further development of the twenty-third embodiment, it is further provided that the transmitter module draws during operation, at times and/or in part, electrical power from the energy supply unit of the receiver module.

In a twenty-fourth embodiment of the invention, it is provided that the sensor module further includes a switch, especially a switch operable through a wall of the sensor housing and/or uniquely operable and/or controllable by means of a switch command transmitted via the transmitter module, especially a pressure switch, a reed switch, a switching transistor, for incorporating the energy storer into the energy supply unit and/or for switching the sensor electronics on.

In a twenty-fifth embodiment of the invention, it is provided that the sensor electronics includes an A/D converter for converting the primary signal delivered by the measuring transducer into a digital signal representing it, especially a digital signal serving as digital, sensor signal.

In a twenty-sixth embodiment of the invention, it is provided that the sensor electronics includes a microprocessor for controlling communication between the sensor module and the transmitter module and/or for generating the sensor signal, especially the digital sensor signal.

In a twenty-seventh embodiment of the invention, it is provided that the transmitter electronics includes a microprocessor for controlling communication between the sensor module and the transmitter module and/or for generating measured values representing the at least one measured variable.

In a twenty-eighth embodiment of the invention, it is provided that:
The energy storer of the energy supply unit of the sensor module is embedded in potting compound, at least partially, especially completely and/or in fulfillment of the requirements of ignition protection type “Potting Compound Encapsulation” (Ex-m); and/or
the sensor housing is embodied explosion protectedly and/or pressure resistantly, especially in a manner satisfying the requirements of ignition protection type “Pressure Resistant Encapsulation” (Ex-d); and/or
the sensor electronics is embodied explosion protectedly, especially in a manner satisfying the requirements of ignition protection type “Intrinsic Safety” (Ex-i) and/or the requirements of ignition protection type “Increased Safety” Ex-e; and/or
the transmitter electronics is embodied explosion protectedly, especially in a manner satisfying the requirements of ignition protection type “Intrinsic Safety” (Ex-i) and/or the requirements of ignition protection type “Increased Safety” (Ex-e).

In a twenty-ninth embodiment of the invention, it is provided that the sensor housing is embodied as a plug-in connectable element and the transmitter housing as a plug-in connectable element complementary to the sensor housing and wherein transmitter housing and sensor housing are connected together to form a plugged coupling, especially a releasable, plugged coupling.

In a thirtieth embodiment of the invention, it is provided that sensor electronics and transmitter electronics are kept, during operation, galvanically isolated from one another, especially lastingly and/or with application of at least one inductively coupling transformer.

In a thirty-first embodiment of the invention, it is provided that the sensor module and transmitter module are electrically coupled together, especially exclusively, by means of a transformer, especially a single transformer.

In a thirty-second embodiment of the invention, it is provided that the transmitter module is supplied by the sensor electronics with electrical energy, especially exclusively, via a galvanic isolation point.

In a thirty-third embodiment of the invention, it is provided that, as sensor signal, an electrical current serves, modulated by means of the sensor electronics, especially in its amplitude and/or frequency, and variable, especially clocked, and/or fed from the transmitter electronics. Developing this embodiment of the invention further, it is additionally provided that the electrical current serving as sensor signal is fed, at least at times, from the energy supply unit of the transmitter module, and serves for supplying the sensor module with electrical energy and/or that the electrical current serving as sensor signal is fed, at least at times, from the energy supply unit of the sensor module and serves for supplying the transmitter module with electrical energy.

In a thirty-fourth embodiment of the invention, it is provided that measuring transducer is a potentiometric sensor, an amperometric sensor, a photometric sensor, a spectrometric sensor, a temperature sensor, a pressure sensor, a flow sensor or a conductivity sensor.

A basis idea of the invention is, for measuring systems, in which battery replacement has, in the past, meant for the user an increased service effort, both from the logistical point of view, as well as regards staffing, to simplify and, therefore, on the whole, also to shorten, the replacement procedure via a scheduled replacement of the complete sensor module (together with the energy storer contained in the sensor module), on occasion a sensor module which is also only usable once and then must be disposed of anyway, such as required, for instance, in the case of fermentation processes.

An advantage of the invention is that, especially in the application of a measuring system of the present invention in applications with a high degree of fouling or with high hygienic requirements, such as, for instance, in water preparation and/or drinking water distribution processes or in processes involving the participation of bacteria, by the replacement of the sensor module together with the energy storer integrated therein, there is achieved, additionally, on the whole, a significant reduction of the amount of time previously required for the maintenance of the measuring system. Further, because of the, on occasion, rather short, nominal service time of the sensor module and, consequently, also of the energy storer contained therein, in some applications in measuring systems, onboard charging circuits for the energy storer placed in the sensor module can even be completely omitted and so, for example, even a primary battery can be applied as energy storer for the sensor module, which, in comparison with secondary batteries, most often have higher storage capacities and/or smaller installed size and thus are, on the whole, more cost effective. For this, only the life, or the storer capacity, of the, in each case, installed energy storer is to be so selected, that it can cover the energy requirement of the functional units of the measuring system fed therewith, for example, thus, the sensor module and/or the transmitter module, in sufficient measure, at least somewhat beyond such a service interval. In other words, the nominal service life of the sensor module should be selected to be smaller than the nominal life, as well as the service life, of the energy storer applied therein, which, in turn, depends on its storage capacity and the electrical energy to be drawn from the energy storer in the service interval. By shifting energy intensive components of the measuring system into the transmitter module, which is, on occasion, likewise provided with internal energy storer and/or supplied from the outside additionally with electrical energy, the service life of the energy storer applied therein, and, as a result, also the service life of the measuring system as a whole, can be further extended. By applying an energy storer in the sensor module to be used, on occasion, as a one-use component, additionally, however, also the integration of more than one measuring transducer is enabled for the purpose of registering different measured variables also in a measuring system connected to a 4-20 mA current loop, which, as is known, delivers only a relatively low, nominal power of about 50 mW.

In the application of the measuring system in explosion-endangered areas, it can, on occasion, also be of advantage to embed at least the energy storer in the sensor module, if not even also the transmitter electronics as a whole, in potting compound and/or to make the sensor housing explosion resistant. For the transmitter electronics and/or the sensor electronics, alternatively thereto or in supplementation thereof, the limit values assuredly excluding explosions can, depending on required protection class, also be achieved by means of current limiting resistors and/or voltage limiting Zener diodes.

The connecting of such a modular measuring system, which, on occasion, is also energetically autarkic, to superordinated, data processing systems can advantageously be effected using plug-in connector systems, as already established in industrial measurements technology, for example inductively, optically or capacitively coupling, plug-in connector systems, formed from two mutually complementary, plug-in connector elements, especially plug-in connector elements lacking plug contacts, such as set forth in the above mentioned U.S. Pat. No. 6,705,898.

Especially also in the case in which the measuring system is embodied to be energetically largely autarkic, as a result of the internal energy storer, it is possible, also in the case of application of the measuring system in a 4-20 mA current loop, on occasion also in the case of use in an explosion-endangered area, to enable, advantageously, an operation of the measuring system with a high availability and a sufficiently good power capability, this even in the case of application of inductive, capacitive or optical coupling having, most often, poor efficiency. This, especially, also because, in the case of the measuring system of the invention, depending on case of application, or on configuration, energy for the purpose of supplying the individual modules must not necessarily be transmitted over the plug connection. Instead, only a communication between sensor module and transmitter module need occur via the plug connection.

### BRIEF DESCRIPTION OF THE DRAWINGS

The invention, as well as further, advantageous embodiments thereof, will now be explained in the following on the basis of an example of an embodiment presented in the drawing, the sole figure of which shows as follows:

FIG. 1 a schematic, block diagram of a measuring system of the invention.

### DETAILED DISCUSSION IN CONJUNCTION WITH THE DRAWING

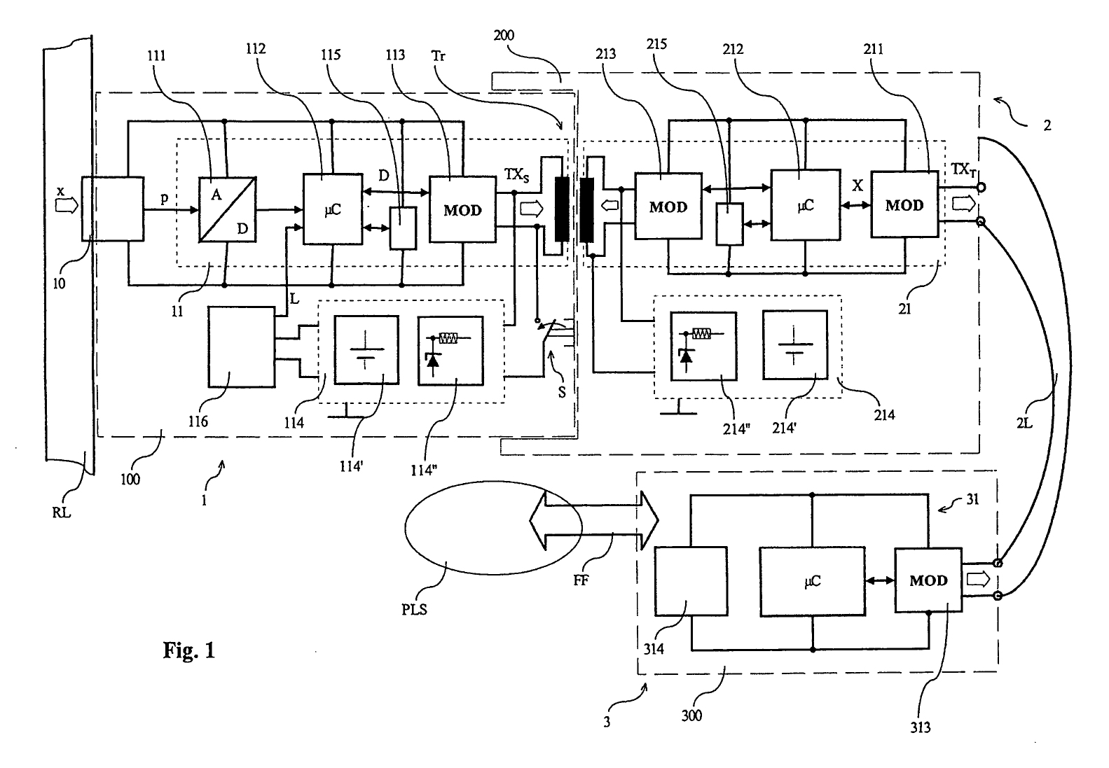

FIG. 1 shows, schematically, a measuring system for measuring at least one physical and/or at least one chemical, measured variable x of a medium, such as, for instance a fluid or a bulk good, conveyed in a line RL, especially a pipeline and/or a flume, and/or held in a container (RL), especially a tank or a basin.

The measuring system includes a sensor module 1 having a measuring transducer 10, for example, a potentiometric sensor, an amperometric sensor, a photometric sensor, a spectrometric sensor, a temperature sensor, a pressure sensor, a flow sensor or a conductivity sensor, which serves, during measuring operation of the measuring system, for registering the at least one measured variable x and, at least at times, for producing at least one, primary signal p, especially an electrical and/or optical, primary signal p, influenced by the measured variable. Measuring transducer 10 is inserted, at least partly, into a sensor housing 100 of the sensor module 1, especially a housing which is hermetically sealed and, if required, also explosion resistant and/or pressure resistant. Sensor housing 100 can be provided, for example, in the shape of a pluggable head, which is arranged on an axial, end section of a measuring transducer which has an externally essentially cylindrical form. Examples include, for example, a pH sensor, a temperature sensor, a pressure sensor or some other measuring transducer in the form of a rod-shaped probe.

Sensor module 1 includes, additionally, an electronic circuit, arranged within the sensor housing 100 and referred to here as sensor electronics 11, for control of the measuring transducer 10 and for processing primary signals produced by means of the measuring transducer 10. Especially, the sensor electronics 11 serves for converting the primary signal p, delivered during measuring operation of the measuring transducer 10 for representing the at least one measured variable x, into a sensor signal TX_{S}. Sensor signal TX_{S} can be, for example, a signal, on occasion also a digital signal, which is transmittable via a galvanically isolated point, such as, for instance, an alternating current, which is amplitude and/or frequency modulated, especially in discrete steps, as a function of the registered, measured variable x. For converting the at least one primary signal p produced by means of the measuring transducer 10, the sensor electronics includes, in the example of an embodiment illustrated here, an A/D converter 111, which digitizes the at least one primary signal p of the measuring transducer 10. The digitized primary signal is led to a microprocessor 112 provided in the sensor electronics 11 for further processing, where it is converted, taking into consideration, for example, sensor specific, parameter values experimentally won in the framework of a calibration of the sensor module 1, into corresponding measured values, such as, for instance, pH measured values, temperature measured values, pressure measured values, conductivity measured values, etc. These can, in due course, be converted by means of a downstream connected modem 113, according to a digital modulation method, such as, for instance, an amplitude or frequency sampling, into the sensor signal TX_{S}, for example also digital sensor signal TX_{S}, tappable at the output of the sensor module.

The sensor signal TX_{S} derived, for example with application of the microprocessor 113, from the at least one primary signal p, is then forwarded to a transmitter module 2, including transmitter electronics 21, of the measuring system, for example by a modulation performed by the sensor electronics 11 by means of modem 113 of an alternating current fed from the transmitter module 2 or from the sensor module 1. Correspondingly, the transmitter electronics 21 serving here, especially, for converting the sensor signal delivered from the sensor module into the measured values representing at least one measured variable, e.g. analog measured values and/or measured values encapsulated into telegrams transmittable via fieldbus and/or wirelessly per radio, and/or digital measured values, includes a corresponding modem 213 (modulator/demodulator), for receiving the sensor signal TX_{S} and, on occasion, further measurement and operating data from the sensor module 1 and/or for transmitting control commands to the sensor module 1, especially for the sensor electronics 2 provided therein. Especially, after a connection of the sensor module 1 to the transmitter module 2, it can, for example, be of advantage, or even necessary, that the transmitter module 2, be it during the startup of the measuring system and/or in the course of operation of the measuring system, transmits to the sensor module 1 at least one time value, for example an internally generated time value and/or a time value transmitted from the outside, to represent a current system time of the measurement system, e.g. also a current date. Based thereon, a synchronizing of sensor module and transmitter module can be implemented in simple manner.

Analogously to the sensor electronics, in the here illustrated example of an embodiment, also the transmitter electronics 21 includes a microprocessor 212, which serves, especially, for the control of communication between the sensor module 1 and the transmitter module 2 and/or for generating measured values X representing the at least one measured variable x, based on the sensor signal TX_{S} of the sensor module 1 received from the transmitter module.

Serving as connection between the sensor module and the transmitter module can be a plug-in connector coupling. For example, as also disclosed in, among others, also U.S. Pat. No. 6,705,898, the sensor housing can be constructed as a pluggable connector element and the transmitter housing as a pluggable connector element which is complementary to the sensor housing, and these can be connected together during operation, in the form of a releasable pluggable connector coupling. In case required, sensor module and transmitter module can also be electrically connected together by means of a connection cable provided between sensor housing and transmitter housing. The pluggable connector coupling can, for example, be implemented in such a manner that one of the pluggable connector elements has plug contacts and the complementary pluggable connector element has corresponding socket contacts. The pluggable connector coupling can, however, also be implemented, such as described, for example, in U.S. Pat. No. 6,705,898, by means of inductively coupling transformer and with the formation of a galvanic isolation point between sensor module and transmitter module, especially in the manner that sensor module and transmitter module are coupled together electrically exclusively by means of one or more transformers and thus are kept lastingly completely galvanically isolated from one another. Accordingly, for example, also the sensor signal TX_{S} to be transmitted from the sensor electronics 11 to the transmitter electronics 21 is formed in such a way, that it can be transmitted via a galvanic isolation point. Thus, for example, the sensor signal TX_{S} can be a variable, especially clocked, electrical current, which is modulated, by means of the sensor electronics 11, in its amplitude and/or a frequency, e.g. according to a frequency shift keying method (FSK) or an amplitude shift keying method (ASK). Alternatively thereto or in supplementation thereof, the transmission of measurement and operating data (TX_{S}) generated by the sensor module 1 to the transmitter module 2, or the transmitting of control commands generated by the transmitter module 2 to the sensor module can occur by means of optocoupler and/or per radio, for example according to the established Bluetooth standard.

For providing electrical power required for operating the measuring system, the sensor module includes, further, an internal energy supply unit 114. For the purpose of increasing the operational safety of the measuring system, it can be advantageous to embed the energy supply unit 114 of the sensor module 1 at least partially in a potting compound and/or to provide in the energy supply unit components limiting a maximally releasable, electrical power. Alternatively thereto or in supplementation thereof, the sensor housing can be constructed, especially in a manner meeting the requirements for the ignition protection type “Pressure Resistant Encapsulation” (Ex-d), also explosion protectedly and/or pressure resistantly and/or the sensor electronics can be constructed, especially in a manner meeting the requirements for the ignition protection type “Intrinsic Safety” (Ex-i) and/or the requirements for the ignition protection type “Increased Safety” (Ex-e), explosion protectedly. Furthermore, it can be of advantage to construct the transmitter electronics explosion protectedly, for example, in a manner meeting the requirements for the ignition protection type “Intrinsic Safety” (Ex-i) and/or the requirements for the ignition protection type “Increased Safety” (Ex-e).

In the case of the measuring system of the invention, the energy supply unit 114 of the sensor module 1 further includes at least one energy storer 114′ arranged within the sensor housing 100, especially an electrochemical and/or rechargeable energy storer, for storing energy to be used in the measuring system. The energy supply unit 114 of the sensor module of the measuring system of the invention is, in an embodiment of the invention, further so embodied that it delivers, using energy stored in the energy storer 114′, at least at times, an electrical power at least partially feeding the sensor electronics 11 and/or the transmitter electronics 21. In other words, the energy supply unit 11 of the sensor module 1 is so constructed, that the sensor electronics and/or the transmitter electronics draws, during operation, in each case, required electrical energy at least partially from the energy storer 114′.

In an advantageous embodiment of the invention, it is further provided that at least the transmitter module is supplied with electrical energy from the sensor electronics, especially exclusively, on occasion also across a galvanic isolation point Tr provided between sensor module and transmitter module.

In another advantageous embodiment of the invention, additionally, electrical power required for operation of the sensor electronics is provided, at least in part, especially predominantly or exclusively, by exploiting energy stored in the energy storer 114′ of the energy supply unit of the sensor module and/or the sensor electronics 11 draws, during operation, at least at times and/or at least in part, on occasion also predominantly or exclusively, electrical power from the energy supply unit of the sensor module. Depending on selected storage capacity of the energy storer 114′, it is, thus, for example, also enabled to construct the sensor module energetically autarkically, thus electrically fed solely by means of its own onboard energy storer.

In another embodiment of the invention, the energy storer 114′ of the energy supply unit 15 of the sensor module is, therefore, further so sized that it, fully charged, can maintain the operation at least of the sensor module, on occasion, however, also the operation together of sensor module and transmitter module, for at least 10 days, especially more than a month. Alternatively thereto or in supplementation thereof, the energy storer is additionally so dimensioned, that it has a storage capacity of at least 3000 mWh, especially more than 5000 mWh, and/or that it has, at a nominal voltage of at least 1 volt, especially more than 3 volt, a nominal capacity of at least 1000 mAh, especially more than 1500 mAh. The energy storer of the energy supply unit 15 of the sensor module can e.g. be formed by means of a primary battery, especially a non-rechargeable, primary battery, and/or a primary battery embodied in the form of a thin-file battery, and/or by means of a secondary battery (accumulator), especially a secondary battery which can be recharged during operation of the measuring system and/or embodied in the form of a thin-film battery. Especially, for example, a lithium battery, such as, for instance, a lithium, manganese dioxide battery (Li—MnO₂), a lithium, thionyl chloride battery (Li—SOCl₂), a lithium, carbon monofluoride battery (Li—{CFₙ})), a lithium, iodine battery (Li—I₂), and/or a lithium, polymer accumulator (LiPoly), a sodium, sulfur accumulator, a nickel, metal hydride accumulator and/or a lithium ion accumulator (Li-ion), such as, for instance, a lithium, iron, phosphate accumulator (LiFe—PO₄), a lithium titanate accumulator, a lithium, cobalt, nickel oxide accumulator, a lithium, manganese oxide accumulator, etc., can be applied as energy storer. Alternatively or in supplementation of the application of a primary and/or secondary battery, the energy storer can, however, also be implemented by means of a fuel cell, especially a fuel cell embodied in the form of a micro fuel cell, and/or by means of a capacitor, especially an electrolytic capacitor, especially an electrochemical, double layer capacitor (EDLC), such as, for instance, especially a Goldcap, a Supercap, a Boostcap, or an Ultracap, double layer capacitor.

For integrating the energy storer, for example an energy storer already charged before the installation of the measuring system and/or before the final connecting of sensor module and transmitter module, into the energy supply unit 15, and/or for switching the sensor electronics on, the sensor module can, furthermore, include a switch S, for instance a switch actuatable through a wall of the sensor housing and/or operable once and/or controllable by means of a switch command transmitted via the transmitter module.

Switch S can be e.g. a push switch, a reed switch or also a switching transistor. For the purpose of increasing the operational safety of the measuring system, it can, furthermore, be of advantage to embed the energy storer 114′ of the energy supply unit 11 of the sensor module 1 at least partially in potting compound, for example also completely and/or in fulfillment of the requirements of ignition protection type “Potting Compound Encapsulation” (Ex-m). Alternatively thereto or in supplementation thereof, the energy supply unit of the sensor module can include current limiters (114″) for limiting electrical power maximally releasable from its energy storer, in the form of limiters such as current limiting resistors and/or voltage limiters (114″), such as, for instance, Zener diodes.

According to a further development of the invention, also, the transmitter module 2 includes, for providing electrical power required for operation of the measuring system, a component (214″), for example a component embedded at least partially in potting compound and/or limiting a maximally releasable electrical power, such as, for instance, energy supply unit 214 equipped with Zener diodes or current limiting resistors, with at least one energy storer 214′ feeding it with electrical energy and placed within the transmitter housing. The energy supply unit 214 of the transmitter module 2 serves, especially, for delivering during operation, by exploiting energy stored in the energy storer 214′, for example an energy storer 214′ also rechargeable during operating of the transmitter module, electrical power feeding, at least partially, at least at times, the transmitter electronics 21. Depending on selected storage capacity of the energy storer 214′, it is thus enabled, also in this case, to construct the transmitter module 2, for example, energetically autarkically, thus fed electrically solely by means of its own onboard energy storer.

Alternatively to or in supplementation of the exploiting of energy stored in the energy storer 214′ of the transmitter module for feeding the transmitter electronics, energy stored in the energy storer 214′ of the transmitter module can, however, also be exploited for supplying the sensor module 1, at least at times, with energy during operating, especially also, in order to feed electrical power into the sensor electronics 11. The supply of the sensor module with electrical energy can then occur in simple manner, thus, for example by means of the electrical current also simultaneously serving also as sensor signal TX_{S}, this electrical current, as a result, thus, being modulated on the load side. In case the electrical energy additionally fed, on occasion, from outside of the sensor module is transmitted by means of alternating current to the sensor module, e.g. in the case of application of a transformer for inductive coupling of sensor electronics and transmitter electronics, it can be of advantage to provide in the energy supply unit of the sensor module a corresponding alternating to direct current converter (AC/DC), which correspondingly rectifies the alternating current.

In another embodiment of the invention, the energy storer of the energy supply unit 214 of the transmitter module is so sized therefor, that the energy storer 214′ maintains the operation at least of the transmitter module, when fully charged, for at least 10 minutes, especially more than 1 hour. Alternatively thereto or in supplementation thereof, the energy storer has a storage capacity of more than 10 mWh and/or, at a nominal voltage of at least 1 volt, especially more than 3 volt, a nominal capacity of at least 1 mAh, especially more than 5 mAh.

Energy storer 214′ of the energy supply unit 214 of the transmitter module can be a capacitor, e.g. an electrolytic capacitor, e.g. a double layer capacitor (EDLC). Alternatively thereto or in supplementation thereof, the energy storer can be formed by means of a secondary battery, for example a lithium, iron, phosphate accumulator (LiFe—PO₄), a lithium titanate accumulator, a lithium, cobalt, nickel oxide accumulator, a lithium, manganese oxide accumulator, a lithium polymer accumulator (LiPoly), a sodium, sulfur accumulator or also a nickel, metal hydride accumulator.

In a further embodiment of the invention, the transmitter module, especially also the transmitter electronics, draws, during operating, at least at times and/or at least in part, electrical power from the energy supply unit 114 of the sensor module. Especially, it is provided, in such case, additionally, that the electrical power required for operation of the transmitter electronics is provided at least in part, depending on nominal capacity of the energy storer also predominantly or exclusively, by exploiting energy stored in the energy storer of the energy supply unit of the sensor module.

To the extent that the transmitter module is fed during operation at least partially from externally of the transmitter module, such, for example, injected electrical can be drawn predominantly or even exclusively from the energy supply unit 114 of the sensor module or supplied with electrical energy predominantly or even exclusively by means of the energy supply unit 114 of the sensor module from externally of the transmitter module. The power fed in by the energy supply unit 114 of the sensor module can, for example, be fed directly to the transmitter electronics. Alternatively thereto or in supplementation thereof, electrical power drawn from the exterior by the transmitter module can serve, additionally, also for the charging of the energy storer provided, on occasion, in the transmitter module. In case the electrical energy injected additionally, on occasion, from externally of the transmitter module by means of alternating current is transmitted to the transmitter module, e.g. in the case of application of a transformer for inductive coupling of sensor electronics and transmitter electronics and/or in the case of an alternating current fed from the sensor module and modulated by means of the sensor module as sensor signal TX_{S}, it can be of advantage to form the energy supply unit of the transmitter module by means of an alternating to direct current converter (AC/DC), which correspondingly rectifies the alternating current and is connected on the output side to the energy storer provided, on occasion, in the transmitter module.

For monitoring a charge state of the at least one energy storer 114′ of the energy supply unit of the sensor module 1 and/or for ascertaining a remaining, especially still usable, charge of the energy storer 114′, the sensor electronics includes, in a further development of the invention, additionally a charge measuring circuit 116, which delivers in operation, at least at times, a charge measurement signal L representing the instantaneous charge state of the at least one energy storer of the sensor module, for example based on an electrical current, voltage measurement. Alternatively thereto or in supplementation thereof, however, also the transmitter electronics can include a charge measuring circuit (not shown) serving for monitoring a charge state of the at least one energy storer 214′ of the energy supply unit of the transmitter module and/or for ascertaining a remaining, especially still usable, charge of the energy storer. During operation, the charge measuring circuit delivers, at least at times, a charge measurement signal representing the instantaneous charge state of the at least one energy storer 214′ of the transmitter module 2. Based on the charge measurement signal generated by the charge measurement circuit, the measuring system can, for example thus by means of the sensor electronics or by means of the transmitter electronics, ascertain during operation a diagnostic value D, which represents an estimated remaining charge of the energy storer and/or a remaining operating time predicted for the energy storer and/or for the sensor module.

By a comparison, correspondingly performed by the measuring system, of the ascertained diagnostic value D with a predetermined reference value, which serves, for example, as an alarm threshold for remaining charge, classified as critical operating state of the measuring system and/or for threatening discharge of the monitored energy storer 214′, thereafter, in the case of detected critical operating state, an alarm suitably signaling this, for example visually on-site and/or perceived remotely from the measuring system, can be generated by the measuring system. Alternatively thereto or in supplementation thereof, the measuring system, especially the sensor electronics, can, based on the ascertained diagnostic value D, also regulate a clocking rate, with which the sensor electronics 1 generates, or modulates, the sensor signal, especially the digitally formed, sensor signal, in order so, for example, to achieve a matching of the still assured service time for the measuring system and the remaining charge usable by the energy storer. Based on the diagnostic value D, for this purpose, additionally, also access times, or access frequencies, to data memories possibly provided in the measuring system, as well as also clocking rates of microprocessors possibly provided in the measuring system, can be regulated.

The sensor electronics 11 includes, in a further embodiment of the invention, additionally, at least one non-volatile data memory 115, in which, on the one hand, sensor specific date, especially calibration data and parameter data for the sensor module, are stored, and, on the other hand, measurement data can be stored. Especially for the case in which the data memory 115 for the storage of transmitter data identifying the transmitter module for the sensor module or for storing of at least one section of a digital signal generated by means of the sensor module, especially based on its at least one primary signal or, however, also for storing measured values generated by means of the transmitter module, the data memory 115 includes persistent memory components, such as, for instance, a flash EPROM or an EEPROM. Such transmitter data identifying the transmitter module for the sensor module can be data e.g. specifying the transmitter module and/or authenticating the transmitter module relative to the sensor module, such as transmitter type identifiers and/or certificates issued for the transmitter module and/or operating approvals granted for the transmitter module. Additionally, it can, in the case of the storing of sections of digital signals generated by means of the sensor module, be of advantage to mark the corresponding data sets stored in the memory correspondingly also by means of a time stamp representing a point in time of their generation. Equally advantageous can be, in the storing of measured values generated by means of the transmitter module, the marking also of stored, measured values, in each case, by means of a time stamp representing an associated time of storing and/or an associated date of storing. Alternatively thereto or in supplementation thereof, the data storer 115 can include, however, permanent storage components, such as, for instance, a PROM or a ROM. This, especially, for the case, in which sensor data identifying the sensor module for the transmitter module, for example sensor data specifying the sensor module and/or authenticating the sensor module relative to the transmitter module, such as sensor type identifiers, calibration data specifying the sensor module and/or operating parameters serving for a parametering of the transmitter module and/or certificates issued for the sensor module and/or operating approvals granted for the sensor module and/or enabling codes serving for activating the transmitter module, can be stored. In a further embodiment of the invention, the transmitter electronics includes, additionally, at least one non-permanent data memory 215, in which, on the one hand, transmitter specific data, especially calibration data and parameter for the transmitter module, are stored, and, on the other hand, measurement data and/or operating data delivered from the sensor module 1, for example also such data stored in its data memory 115, can be stored. Data memory 215 can, on the other hand, be formed by means of persistent memory components, especially for the storage of measured values generated by means of the transmitter module, on occasion marked by means of a time stamp representing a point in time of the pertinent generating, for storage of sensor data identifying the sensor module for the transmitter module, or specifying the sensor module, as the case may be, or, however, also for the storing of sensor data authenticating the sensor module relative to the transmitter module, such as, for instance, a sensor type identifier and/or calibration data specifying the sensor module and/or certificates issued for the sensor module and/or operating approvals issued for the sensor module and/or an enabling code serving for activating the sensor module. Alternatively thereto or in supplementation thereof, the data memory can, however, include permanent memory components, especially for the case that it is applied for storing transmitter data identifying the transmitter module for the sensor module or authenticating the transmitter module relative to the sensor module, such as, for instance, a transmitter type identifier, operating parameters serving for a parametering of the sensor module, a certificate issued for the transmitter module, an operating approval granted for the transmitter module or, however, also an enabling code serving for an activating of the sensor module.

In the example of an embodiment illustrated here, data generated and/or stored in the transmitter module 3 can, furthermore, be forwarded to a receiver module 3 in the form of a programmable logic controller (PLC) or in the form of a separate measurement transmitter connected to a field bus, with the receiver module 3 having an associated receiver electronics 31, accommodated here in a single, receiver housing 300. The transmitter electronics 21, for example connected electrically by means of connection lines 2L, sends to the remote receiver module 3, for example connected to a fieldbus FF and/or to a superordinated, electronic, data processing system PCS, at least at times, a measured value TX_{T} and/or a parameter value signaling a current operating state of the transmitter module 2 and/or of the sensor module 1. Suitable as format of the communication between the transmitter module 2 and the receiver module 3 is e.g. the standard interface RS485 or 4-20 mA current loop. Alternatively or in supplementation, data can be transmitted between transmitter module and receiver module, for example, also wirelessly per radio, for example by means of the standard interface Bluetooth. Accordingly, measured values to be transmitted by the transmitter module 2 to the receiver module 3 can be output e.g. as analog measured values or also as digital measured values, occasionally also measured values encapsulated in a telegram transmittable via connecting line 2L and/or wirelessly per radio. Serving for separating, or for joining, as the case may be, of data and signal carrier can be modems 211, 313 correspondingly provided, respectively, in the transmitter module 2 and in the receiver module 3 and communicating with one another during operation.

In a further embodiment of the invention, in such case, it is further provided that the transmitter module 2 sends, at the latest at interrupted communication between sensor module and transmitter module, for example as a result of the turning off, or removal, of the sensor module by service personnel active on-site, to the receiver module 3 at least one parameter value, which signals that the sensor module is momentarily out of operation. This can be performed automatically e.g. by the transmitter module 2 or, however, also initiated by service personnel, on occasion also directly before actual removal of the sensor module. In the latter case, it can, additionally, be of advantage, when type and/or predicted length of the interruption is queried by means of the transmitter module and, on occasion, transmitted to a superordinated data processing system possibly communicating with the measuring system and/or to another measuring system.

Moreover, it can be of advantage that also the receiver module 3 includes an energy supply unit 314 for feeding electrical power into the transmitter module 3. For this case, the transmitter module 2, above all also the transmitter electronics 21, can draw, during operation, at times and/or in part, electrical power from the energy supply unit of the receiver module and, in this way, at least partially, cover its energy requirement. The electrical power drawn by the transmitter module 2 from the energy supply unit of the receiver module 3 can serve, especially, for recharging, at least partially, the energy storer 221 provided, on occasion, in the energy supply unit of the transmitter module.

1. A measuring system for measuring at least one physical and/or at least one chemical, measured variable, which measuring system comprises:
a sensor module, especially an energetically autarkic, sensor module, said sensor module includes: a sensor housing, especially a sensor housing embodied as a element connectable by plugging and/or an explosion resistant and/or pressure resistant, sensor housing, at least one measuring transducer arranged at least partially in said sensor housing for registering the at least one measured variable and for producing at least one primary signal influenced by the measured variable, sensor electronics arranged within said sensor housing and connected with said at least one measuring transducer, especially a sensor electronics formed by means of a microprocessor, for converting the primary signal delivered from said at least one measuring transducer into a sensor signal, especially a digital sensor signal and/or a sensor signal transmittable via a galvanic isolation point, and an energy supply unit, especially an energy supply unit at least partially embedded in a potting compound and/or an energy supply unit having a component limiting maximally releasable electrical power, said energy supply unit has at least one energy storer arranged within said sensor housing, especially an electrochemical and/or rechargeable, energy storer, for storing energy to be converted in said at least one measuring system; and
a transmitter module coupled to said sensor module, especially by means of coupling connectable by plugging, especially a transmitter module connected releasably and/or via connecting cable with said sensor module, said transmitter module includes: a transmitter housing, especially a transmitter housing in the form of an element connectable by plugging, and a transmitter electronics accommodated in said transmitter housing and electrically coupled with said sensor electronics, especially electrically coupled with galvanic isolation, especially a transmitter electronics for converting the sensor signals delivered from said sensor module, especially sensor signals transmitted from said sensor electronics to said transmitter electronics via galvanic isolation point, into measured valued representing the at least one measured variable, especially analog measured values and/or measure values encapsulated in a telegram transmittable via fieldbus and/or wirelessly per radio and/or digital measured values.

2. The measuring system as claimed in claim 1, wherein:
said energy supply unit delivers, by exploiting energy stored in said energy storer, electrical power feeding, at least at times, at least in part, said sensor electronics and/or said transmitter electronics.

3. The measuring system as claimed in claim 1, wherein:
said transmitter module draws, during operation, at least at times and/or at least in part, electrical power from said energy supply unit of said sensor module.

4. The measuring system as claimed in claim 1, wherein:
said transmitter module draws, during operation, electrical power fed in from externally of said transmitter module, especially predominantly or exclusively from said energy supply unit of said sensor module.

5. The measuring system as claimed in claim 1, wherein:
said transmitter module is supplied with electrical energy at least in part, especially predominantly or exclusively, by means of said energy supply unit of said sensor module, from externally of said transmitter module.

6. The measuring system as claimed in claim 1, wherein:
electrical power required for operation of said transmitter electronics is provided, at least in part, especially predominantly or exclusively, by exploiting energy stored in said energy storer of said energy supply unit of said sensor module.

7. The measuring system as claimed in claim 1, wherein:
said transmitter electronics draws, during operation, at least at times and/or at least in part, electrical power from said energy supply unit of said sensor module.

8. The measuring system as claimed in claim 1, further comprising:
electrical poser required for operation of the sensor electronics, at least in part, especially predominately or exclusively, by exploiting energy stored in said energy storer of said energy supply unit of said sensor module.

9. The measuring system as claimed in claim 1, wherein:
said sensor electronics draws, during operation, at least at times and/or at least in part, especially predominantly or exclusively, electrical power from said energy supply unit of said sensor module.

10. The measuring system as claimed in claim 1, wherein:
said energy storer of said energy supply unit of said sensor module is so sized that said energy storer, fully charged, maintains operation at least of said sensor module, especially, however, also operation of both sensor module and transmitter module, for at least 10 days, especially more than one month, and/or that said energy storer has a storage capacity of at least 3000 mWh, especially more than 5000 mWh, and/or that said energy storer, at a nominal voltage of at least 1 volt, especially more than 3 volt, has a nominal capacity of at least 1000 mAh, especially more than 1500 mAh.

11. The measuring system as claimed in claim 1, wherein:
said energy storer of said energy supply unit of said sensor module is formed by means of a primary battery, especially a non-rechargeable, primary battery and/or a primary battery in the form of a thin film battery, and/or by means of a secondary battery (accumulator), especially a secondary battery rechargeable during operation of the measuring system and/or a secondary battery in the form of a thin film battery, and/or by means of a fuel cell, especially a fuel cell in the form of a micro fuel cell and/or by means of a capacitor, especially an electrolytic capacitor, especially an electrochemical, double layer capacitor.

12. The measuring system as claimed in claim 1, wherein:
said energy storer of said energy supply unit of said sensor module is formed by means of a lithium battery, especially a lithium, manganese dioxide battery (Li—MnO₂), lithium thionyl chloride battery (Li—SOCl₂), lithium, carbon monofluoride battery (Li—{CFₙ}), lithium, iodine battery (Li—I₂), and/or by means of a lithium, ion accumulator (Li-ion).

13. The measuring system as claimed in claim 1, wherein:
said energy storer of said energy supply unit of said sensor module is formed by means of a lithium, iron, phosphate accumulator (LiFe—PO₄), by means of lithium titanate accumulator, by means of a lithium, cobalt, nickel oxide accumulator, by means of a lithium, manganese oxide accumulator, by means of a lithium, polymer accumulator (LiPoly), by means of a sodium, sulfur accumulator and/or by means of a nickel, metal hydride accumulator.

14. The measuring system as claimed in claim 1, wherein:
said energy storer of said energy supply unit of said sensor module is formed by means of a double layer capacitor (EDLC), especially a Goldcap, a Supercap, a Boostcap or an Ultracap double layer capacitor.

15. The measuring system as claimed in claim 1, wherein:
said energy supply unit of said sensor module includes an electrical current limiter and/or a voltage limiter for limiting maximally releasable electrical power from its energy storer.

16. The measuring system as claimed in claim 1, wherein:
said energy supply unit of said sensor module includes a charge measuring circuit monitoring a charge state of said at least one energy storer and/or ascertaining a remaining charge, especially a still usable, remaining charge, of said energy storer; and
said charge measuring circuit delivers during operation, at least at times, a charge measurement signal representing an instantaneous charge state of said at least one energy storer.

17. The measuring system as claimed in claim 16, wherein:
the measuring system, especially said transmitter electronics, ascertains, based on the charge measurement signal generated by said charge measurement circuit, during operation, a diagnostic value, which represents an estimated remaining charge of said energy storer and/or a remaining operating time predicted for said energy storer and/or for said sensor module.

18. The measuring system as claimed in claim 17, wherein:
the measuring system, especially said transmitter electronics, compares the ascertained diagnostic value with a predetermined reference value, which serves as an alarm threshold for a remaining charge classified as a critical operating state of the measuring system and/or for threatening discharge of said energy storer; and
the measuring system, especially said transmitter electronics, generates, based on the comparison of diagnostic values and reference value, at a detected, critical operating state, an alarm signaling this, especially visually on-site and/or remotely from the measuring system.

19. The measuring system as claimed in claim 17, wherein:
the measuring system, especially said sensor electronics, based on ascertained diagnostic value, regulates a clocking rate, with which said sensor electronics generates the sensor signal, especially a digital sensor signal.

20. The measuring system as claimed in claim 1, wherein:
said transmitter module transmits during operation at least one time value to said sensor module, which represents a current system time of the measuring system, especially also a current date.

21. The measuring system as claimed in claim 1, wherein:
said transmitter module further includes an energy supply unit, especially an energy supply unit at least partially embedded in a potting compound and/or an energy supply unit having components limiting a maximally releasable electrical power, said energy supply unit includes at least one energy storer feeding the energy supply unit with electrical energy and placed within said transmitter housing, especially a rechargeable energy storer;
said energy supply unit delivers electrical power by exploiting energy stored in said energy storer for feeding, at least partly, at least at times, said transmitter electronics and/or said sensor electronics.

22. The measuring system as claimed in claim 21, wherein:
said sensor module draws during operation, at least at times, electrical power from said energy supply unit of said transmitter module.

23. The measuring system as claimed in claim 21, wherein:
said energy storer of said energy supply unit of said transmitter module is so sized that said energy storer, fully charged, maintains operation of at least said transmitter module for at least 10 minutes, especially more than 1 hour and/or that said energy storer has a storage capacity of more than 10 mWh and/or that it has, at a nominal voltage of at least 1 volt, especially more than 3 volt, a nominal capacity of at least 1 mAh, especially more than 5 mAh; and/or
said energy storer of said energy supply unit of said transmitter module is formed by means of a capacitor, especially an electrolytic capacitor, especially a double layer capacitor (EDLC), and/or by means of a secondary battery, especially a lithium, iron, phosphate accumulator (LiFe-PO₄), a lithium titanate accumulator, a lithium, cobalt, nickel oxide accumulator, a lithium, manganese accumulator, a lithium, polymer accumulator (LiPoly), a sodium, sulfur accumulator and/or a nickel, metal hydride accumulator.

24. The measuring system as claimed in claim 21, wherein:
said energy supply unit of said transmitter module includes electrical current limiters and/or voltage limiters for limiting electrical power maximally releasable from its energy storer.

25. The measuring system as claimed in claim 21, wherein:
said energy storer of said energy supply unit of said transmitter module is rechargeable, especially during operation of said transmitter module.

26. The measuring system as claimed in claim 1, wherein:
said sensor electronics includes at least one non-volatile, especially persistent, data memory, for storing at least one section of a digital signal generated by means of said sensor module, especially a section marked by means of a time stamp representing a point in time of generation, especially a digital signal based on the at least one primary signal of said sensor module, and/or storing measured values generated by means of said transmitter module, especially measured values marked, in each case, by means of a time stamp representing an associated storage time and/or an associated storage date, and/or storing transmitter data identifying said transmitter module for said sensor module, especially transmitter data specifying said transmitter module and/or authenticating said transmitter module relative to said sensor module, especially transmitter data in the form of transmitter type identifiers and/or certificates issued for said transmitter module and/or operating approvals granted for said transmitter module.

27. The measuring system as claimed in claim 1, wherein:
said sensor electronics includes at least one, non-volatile, especially permanent, data memory for storing sensor data from said sensor module for identifying said transmitter module, especially sensor data specifying said sensor module and/or authenticating said sensor module relative to said transmitter module, especially sensor data in the form of sensor type identifiers, calibration data specifying said sensor module and/or operating parameters serving for a parametering of said transmitter module and/or certificates issued for said sensor module and/or operating approvals granted for said sensor module and/or enabling codes serving for an activating of said transmitter module.

28. The measuring system as claimed in claim 1, wherein:
said transmitter electronics includes at least one non-permanent, especially persistent, data memory for storing measured values generated by means of said transmitter module, especially measured values marked by means of a time stamp representing a point in time of the pertinent generating and/or storing sensor data identifying said sensor module for said transmitter module, especially sensor data specifying said sensor module, and/or storing sensor data authenticating said sensor module relative to said transmitter module, especially sensor data in the form of sensor type identifiers and/or calibration data specifying said sensor module and/or certificates issued for said sensor module and/or operating approvals granted for said sensor module and/or enabling codes serving for an activating of said sensor module.

29. The measuring system as claimed in claim 1, wherein:
said transmitter electronics includes at least one non-volatile, especially permanent, data memory for storing transmitter data identifying said transmitter module for said sensor module, especially transmitter data specifying said transmitter module and/or authenticating said transmitter module relative to said sensor module, especially transmitter data in the form of transmitter type identifiers, and/or operating parameters serving for a parametering of said sensor module and/or certificates issued for said transmitter module and/or operating approvals granted for said transmitter module and/or enabling codes serving for an activating of said sensor module.

30. The measuring system as claimed in claim 1, further comprising:
a receiver module remote from said transmitter module, especially a receiver module connected to a fieldbus and/or a receiver module connected to a superordinated, electronic data processing system, wherein:
said receiver module includes receiver electronics, to which said transmitter electronics, especially a transmitter electronics electrically connected thereto by means of a connecting line, transmits, at least at times, a measured value, especially an analog measured value and/or a measured value encapsulated in a telegram transmittable via connection line and/or wirelessly per radio and/or a digital measured value, and/or a parameter value signaling a current operating state of said transmitter module and/or of said sensor module.

31. The measuring system as claimed in claim 30, wherein:
said transmitter module sends, especially automatically, to said receiver module, at the latest at interrupted communication between said sensor module and said transmitter module, especially as a result of switching off or removal of said sensor module, at least one parameter value signaling that said sensor module is momentarily out of operation.

32. The measuring system as claimed in claim 30, wherein:
said receiver module includes an energy supply unit for feeding electrical power into said transmitter module.

33. The measuring system as claimed in claim 32, wherein:
said transmitter module, especially said transmitter electronics, draws, during operation, at least at times and/or in part, electrical power from said energy supply unit of said receiver module.

34. The measuring system as claimed in claim 33, wherein:
electrical power drawn from said energy supply unit of said receiver module by said transmitter module serves at least partially for said recharging said energy storer of said energy supply unit of said transmitter module.

35. The measuring system as claimed in claim 32, wherein:
said transmitter module draws, in operation, electrical power fed in from externally of said transmitter module, partially from said energy supply unit of said receiver module.

36. The measuring system as claimed in claim 32, wherein:
said transmitter module is supplied with electrical energy, in part, by means of said energy supply unit of said receiver module from externally of said transmitter module.

37. The measuring system as claimed in claim 32, wherein:
said transmitter electronics draws, during operation, at least at times and/or in part, electrical power from said energy supply unit of said receiver module.

38. The measuring system as claimed in claim 1, wherein:
said sensor module further includes:
a switch, especially a switch operable through a wall of said sensor housing and/or operable once and/or controllable by means of a switching command sent via said transmitter module, especially a push switch, a reed switch, a switching transistor, for incorporating said energy storer into the energy supply unit and/or for switching on said sensor electronics.

39. The measuring system as claimed in claim 1, wherein:
said sensor electronics includes an A/D converter for converting the primary signal delivered from said measuring transducer into a digital signal representing it, especially a digital signal serving as digital sensor signal.

40. The measuring system as claimed in claim 1, wherein:
said sensor electronics includes a microprocessor for controlling a communication between said sensor module and said transmitter module and/or for generating the sensor signal, especially the digital sensor signal.

41. The measuring system as claimed in claim 1, wherein:
said transmitter electronics includes a microprocessor for controlling communication between said sensor module and said transmitter module and/or for generating measured values representing the at least one measured variable.

42. The measuring system as claimed in claim 1, wherein:
said energy storer of said energy supply unit of said sensor module is embedded in potting compound, at least partially, especially completely and/or in fulfillment of the requirements of the ignition protection type “Encapsulated in Potting Compound” (Ex-m); and/or
said sensor housing is embodied in a manner satisfying the requirements for ignition protection type “Pressure Resistant Encapsulation” (Ex-d), explosion protectedly and/or pressure resistantly; and/or
said sensor electronics is embodied explosion protectedly, especially in a manner satisfying the requirements of ignition protection type “Intrinsic Safety” (Ex-i) and/or the requirements of ignition protection type “Increased Safety” (Ex-e); and/or
said transmitter electronics is embodied explosion protectedly, especially in a manner satisfying the requirements of ignition protection type “Intrinsic Safety” (Ex-i) and/or the requirements of ignition protection type “Increased Safety” (Ex-e).

43. The measuring system as claimed in claim 1, wherein:
said sensor housing is embodied as an element connectable by plugging and said transmitter housing has an element connectable by plugging complementary to said sensor housing; and
said transmitter housing and said sensor housing are connected together with the formation of a coupling connected by plugging, especially a coupling which is releasable.

44. The measuring system as claimed in claim 1, wherein:
said sensor electronics and said transmitter electronics are kept galvanically isolated from one another during operation, especially lastingly and/or with application of at least one inductively coupling transformer.

45. The measuring system as claimed in claim 1, wherein:
said sensor module and said transmitter module are electrically coupled together, especially exclusively, by means of a transformer, especially a single transformer.

46. The measuring system as claimed in claim 1, wherein:
said transmitter module is supplied with electrical energy from said sensor electronics, especially exclusively, via a galvanic isolation point.

47. The measuring system as claimed in claim 1, wherein:
a variable electrical current modulated by means of said sensor electronics, especially an electrical current modulated in its amplitude and/or a frequency, especially a clocked electrical current and/or an electrical current fed from said transmitter electronics, serves as the sensor signal.

48. The measuring system as claimed in claim 47, wherein:
the electrical current serving as a sensor signal is fed from said energy supply unit of said transmitter module and serves for supply of said sensor module with electrical energy.

49. The measuring system as claimed in claim 47, wherein:
said electrical current serving as a sensor signal is fed from said energy supply unit of said sensor module and serves for supply of said transmitter module with electrical energy.

50. The measuring system as claimed in claim 1, wherein:
said measuring transducer is one of:
a potentiometric sensor, an amperometric sensor, a photometric sensor, a spectrometric sensor, a temperature sensor, a pressure sensor, a flow sensor and a conductivity sensor.
